(19) United States
(12) Patent Application Publication
(10) Pub. No.: US 2021/0301183 A1
(43) Pub. Date: Sep. 30, 2021

(54) LOW SURFACE ENERGY ACCELERATED BONDING ADHESIVE FORMULATION AND PROCESS FOR THE USE THEREOF

(71) Applicant: Illinois Tool Works Inc., Glenview, IL (US)

(72) Inventors: Ajay Khongal, Glenview, IL (US); Mona Kulkarni, Glenview, IL (US); Steven T. Chao, Glenview, IL (US); Subodh Deshpande, Glenview, IL (US)

(73) Assignee: Illinois Tool Works Inc., Glenview, IL (US)

(21) Appl. No.: 17/205,152

(22) Filed: Mar. 18, 2021

Related U.S. Application Data
(60) Provisional application No. 62/993,924, filed on Mar. 24, 2020.

(51) Int. Cl. C09J 133/10; C09J 5/00; C08K 5/55; C08K 5/56; C08K 5/17

(52) U.S. Cl. CPC C09J 133/10; C09J 5/00; C08K 5/0016; C08K 5/56; C08K 5/17; C08K 5/55

(57) ABSTRACT

An adhesive two-part formulation is provided that includes an amount of free-radical curable monomers, each of said free-radical curable monomers containing at least one acrylate moiety or at least one methacrylate moiety, a Lewis acid, a thermoplastic resin; and a polymeric impact modifier. Also present in the formulation is an amount of an activator of borane-amine complex, a metal accelerator; and a grafted elastomer with a thermoplastic additive. A process of applying the formulation to a substrate includes mixing together the formulation components such that each part has a storage stability at 50° C. for 30 days where the viscosity at 30 days is within 40% of an initial viscosity. The mixture is applied to the substrate and then allowed to cure to achieve an initial strength of at least 1 MPa lap shear strength within 45 minutes.

### RELATED APPLICATIONS

This application claims priority of U.S. Provisional Patent Application Ser. No. 62/993,924 filed Mar. 24, 2020; the contents of which are incorporated herein by reference.

### FIELD OF THE INVENTION

The present invention in general relates to adhesives, and in particular to free radical accelerated curing adhesives with increased shear strengths to adhere to low surface energy substrates with a rapid build of adhesive strength.

### BACKGROUND OF THE INVENTION

Adhesive formulations capable of bonding to low energy surfaces such as polyolefins are now commonplace. The ability to adhesively bond to a surface with a limited number of available bonding sites and characterized by a surface energy value of less than approximately 48 miliJoules per meter squared (mJ/m²) has been addressed in the past through surface activation of the low energy surface through various treatments such as exposure to flame, plasma, ion bombardment, or other processes to create reactive moieties to which an adhesive could bond. While such low energy surface modification treatments proved effective, these treatments have met with limited acceptance owing to the cost, limited duration of surface activation, and the impracticality of surface treatment in field usage or to bond large area substrates.

Resort to primer compositions intermediate between a low energy surface and an adhesive were found to address in part the limitations of high energy surface treatments, yet such primers add to the cost and complexity of bonding thereby limiting instances of practical usage. Additionally, the strength of low energy surfaces adhesively bonded through resort to primers have compromised strength owing to interfacial delamination.

In response to these limitations, adhesive formulations have been developed that rely on organoboranes as free radical polymerization initiators to induce cure of an adhesive formulation and simultaneously promote adhesive bonding to a contacting substrate. Exemplary of such compositions are those detailed in U.S. Pat. Nos. 5,106,928; 6,706,831; and 5,935,711. Organoborane amine complexes overcame many of the stability issues associated with organoboranes and represent the state-of-the art in adhesive bonding to low energy surfaces. Unfortunately, while organoborane amine complex formulations overcome many of the aforementioned problems of energy surface treatments, primers, and unstable organoboranes, persistent limitations of these formulations have led to limited market acceptance. Additionally, conventional organoborane amine complex formulations have a slower than desired cure rate, with adhesive strength developing slowly as evidenced by a single lap shear strength of 345 kilopascals (kPa) taking approximately two hours to develop, as measured by ASTM D 1002 at standard temperature and pressure (STP). Additionally, these conventional formulations suffer from poor storage thermal stability at elevated temperatures of above 40° C. that are often experienced by adhesive formulations prior to usage in storage. Furthermore, commercially available methacrylate based structural adhesive for bonding low surface energy surfaces are not stable at room temperature and require refrigerated storage, which is not optimal or feasible under global climatic conditions.

U.S. Pat. No. 9,382,452 assigned to the assignee of this application, which is incorporated herein by reference, provided an improved adhesive formulation for bonding of polypropylene and other low surface energy substrates with improved overlap shear strength and handling strength when compared to prior adhesives using a two-component methacrylate based adhesive system.

Despite the numerous advantages of structural adhesives over the more traditional mechanical methods of joining, such as by clamps, nuts and bolts, etc., one of the most important reasons these aforementioned adhesives have not made more sizable inroads into industrial bonding applications is their lack of speed in curing. This is particularly true in manufacturing operations where it is not convenient to apply adhesives to parts and store them for long periods of time to allow the adhesives to cure in the conventional manner, especially when alignment is important, and the parts must be maintained in a specific position or configuration until adequate curing of the adhesive has taken place.

It is further noted that while U.S. Pat. No. 9,382,452 provided an improved adhesive formulation (herein referred to as the 452′ formulation) the overlap strength is on the lower side and requires further improvement in view of current industry requirement for efficient bonding on low energy surface substrates. It is further noted that the 452′ formulation requires an extended period of time of cure and for example, the bonded substrates have taken 5 hours of time to achieve more than 50% of total lap shear strength.

Thus, there exists a need for an enhanced low surface energy bonding adhesive formulation able to develop initial strength with rapid cure more quickly than conventional formulations, and to do so without resort to prior low surface energy substrate treatment. There also exists a need for such a formulation that has superior thermal stability to promote formulation storage prior to usage.

### SUMMARY OF THE INVENTION

An adhesive two-part formulation is provided that includes an amount of free-radical curable monomers, each of the free-radical curable monomers containing at least one acrylate moiety or at least one methacrylate moiety, a Lewis acid, a thermoplastic resin; and a polymeric impact modifier. An activator part B includes of borane-amine complex of a trimethylborane, triethylborane, tri-n-propylborane, triisopropylborane, tri-n-butylborane, triisobutylborane, and tri-sec-butylborane, or a combination thereof, The activator includes a metal accelerator, and a grafted elastomer with a thermoplastic additive. A process of applying an adhesive to a substrate includes mixing together the components of an aforementioned two-part formulation wherein each of the two parts has storage stability at 50° C. for 21 days and in some instances 30 days or more such that viscosity at storage is within 20% of an initial viscosity. The mixture is applied to the substrate and then allowed to cure to achieve an initial strength of at least at least 1 MPa lap shear strength within 45 minutes.

### DETAILED DESCRIPTION OF THE INVENTION

The present invention has utility as a curing adhesive particularly well-suited for bonding to low surface energy substrates such as polyolefins. Polyolefins are synonymously referred to herein as thermal plastic polyolefins (TPOs). The TPOs operative herein illustratively include polypropylene, glass filled polypropylene, polybutene, polyisoprene and copolymers containing subunits thereof, fluorinated analogs thereof, and copolymers containing subunits of any of the aforementioned olefins. Other low surface energy substrates that are adhered by an inventive formulation illustratively include aluminum, grit blasted mild steel (GBMS), E-coated steel, glass, wood, acrylonitrile-butadiene-styrene (ABS), Nylon 6, Nylon 66, CFRP and closed molded composites. An inventive formulation is particularly useful for bonding low surface energy substrates to one another, as well as to other substrates including metals, and other plastics so as to build strength quickly during cure to facilitate handling and substrate disengagement with fixturing devices in a manufacturing setting.

Embodiments of the inventive formulation provide an adhesive system capable of rapid bonding of parts that is a major improvement over the prior art adhesives with longer curing times. The cure of adhesive described in embodiments of the present invention may be initiated by certain free radical generators, most commonly a peroxy type polymerization initiator to achieve rapid development of strength. In specific inventive embodiments, a metal accelerator that is capable of markedly increasing the activity of adhesive bonding may be present in the formulation. In specific inventive embodiments of the adhesive, reducing agents may initiate the polymerization process in the presence of an initiator. In modified formulations of the inventive adhesive, a reducing agent based on aldehyde-amine condensate reaction products may be used in combination with the initiator (by keeping separated from each other in either Component A or Component B). In specific inventive embodiments of the adhesive formulation, thermoplastic resin may be used to increase the toughness of material in synergy with a polymeric impact modifier in the formulation.

Embodiments of the inventive adhesive formulation provide faster initial development of lap shear strength and handling strength, as compared to prior art and commercially available low energy surface adhesives systems. Embodiments of the adhesive formulation have achieved overlap shear adhesion of 0.68 MPa (100 psi), within 30 minutes which is a typical handling strength target. The adhesive formulation achieves a high early development of strength without compromising performance that combines excellent physical properties such as stability, flexibility, robustness, and as well as excellent bonding to TPO after curing particularly suitable for automated handling and application, in particular by fast robotic equipment. The inventive adhesive formulation is suitable as a potential alternative to replace fasteners in the automobile industry, which are used to bond low surface energy plastic substrates.

Embodiments of the inventive adhesive formulation do not require surface treatments such as plasma, flame treatment, and primer coating to bond low energy surface substrates. Furthermore, embodiments of the formulation are suitable to bond various surfaces at different temperatures ranging from −30° C. to +60° C.

The addition of a peroxide-based initiator alone, or in combination with an increase in the cross-linker content as compared to the 452′ formulation in an adhesive part of embodiments of the inventive present formulation along with the addition of metal complex accelerator and dihydropyridine based free radical polymerization, and a reducing agent in an activator part of the present formulation, are responsible for the following in specific embodiments with the understanding that an inventive embodiment need not achieve all of the attributes to still be within the scope of the inventive improvements:
Generating more than 100 psi lap shear strength at room temperature within 30 minutes.
Generating more than 70% of the total lap shear strength at room temperature in 2 hours
Generating more than 100 psi lap shear strength at 50° C. in 10 minutes of dwell time.
Achieving 70% of full cure strength within 15 minutes at 50° C. which was tested after 10 minutes of cool down time at room temperature.
Achieving 80% of full cure strength within 10 minutes at 70° C. which was tested after 10 minutes of cool down time at room temperature.
Achieving 90 to 95% of full cure strength within 15 minutes at 70° C. which was tested after 10 minutes of cool down time at room temperature.
The formulation described in the present invention generates more than 1.0 MPa lap shear strength at 50° C. in 10 minutes of dwell time.
The formulation described in the present invention generates more than 1.0 MPa lap shear strength at 50° C. in 15 minutes of dwell time.
The formulation described in the present invention generates more than 1.0 MPa lap shear strength at 80° C. in 10 minutes of dwell time.
The formulation described in the present invention generates more than 0.15 MPa lap shear strength at room temperature in 20 minutes of dwell time.
The formulation described in the present invention generates more than 1 MPa lap shear strength at room temperature in 45 minutes of dwell time.
The formulation described in the present invention generates more than 50% of the total lap shear strength at room temperature in 2 hours of dwell time.

It is further noted that embodiments of the inventive adhesive formulation provide a longer pot-life profile of between 3 to 4 minutes over the 452′ formulation. This enables the formulation to bond larger substrates that require more than two minutes of assembly time.

Embodiments of the inventive adhesive formulation do not require refrigerated storage, as opposed to most of the currently commercially available low energy surface adhesives systems. Embodiments of the present formulation are thermally stable, and may be stored at 62° C. for 7-10 days. The room temperature lap shear strength development and accelerated heat curing profiles of the stored formulation of the inventive embodiments are superior to the 452′ formulation. In addition, embodiments of the formulation have withstood heat aging and humidity test cycles. Furthermore, embodiments of the inventive formulation are stable under cold conditions, which is observed by storing samples at subzero temperatures.

Specific embodiments of the inventive formulation can withstand one or more of the following numerous number of heat aging and humidity test cycles as outlined below:
Standard OLS—After assembling the specimen at RT, kept at 23° C. & 50% RH for 7 days and then tested for lap shear strength
Heat aging test—After assembling the specimen at RT, kept at 23° C. & 50% RH for 7 days and then kept at 120° C. for 24 hrs and then tested for lap shear strength
Heat aging test—After assembling the specimen at RT, keep at 23° C. & 50% RH for 7 days and then kept at 90° C. for 21 days and then tested for lap shear strength
Heat aging test—After assembling the specimen at RT, keep at 23° C. & 50% RH for 7 days and then kept at 90° C. for 21 days and then tested for lap shear strength
Heat and Humidity aging test—After assembling the specimen at RT, keep at 23° C. & 50% RH for 7 days and then kept at 70° C. & 94-100% RH for 21 days and then tested for lap shear strength
PV 1200 test—Heat and Humidity aging test—After assembling the specimen at RT, keep at 23° C. & 50% RH for 168 hrs and run PV 1200 test for 10 cycles and then tested for lap shear strength.

Embodiments of the inventive formulation are provided as a two-part formulation that includes an adhesive part that is synonymously referred to as Part A or an adhesive Part A. The adhesive part of inventive formulation as a two-part formulation in prototypical form includes all the components active in the polymerization reaction except that an organoborane compound, which is predominantly in an activator part that is synonymously referred to as Part B. The following components of an inventive formulation are detailed as weight percentages of a formulated Part A or Part B inclusive of all components except diluents that are non-reactive under free radical cure conditions.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Tables 1A and 1B lists the components present in embodiments of the inventive adhesive formula with weight percentage/ratio:

TABLE 1A
Components of two-part adhesive

| Components | Parts per 100 |
|---|---|
| Methacrylate Monomer | 45 to 65 parts |
| Lewis acid | 2 to 10 parts |
| Thermoplastic resin | 0.1 to 5 parts |
| Inhibitor | 0.01 to 0.1 parts |
| Peroxide | 0.1 to 1.0 parts |
| Fumed silica | 0.1 to 2.0 parts |
| Polymeric impact modifier | 15 to 35 parts |
| Plasticizer | 15 to 45 parts |
| Uncoated Calcium carbonate | 10 to 45 parts |
| Precipitated Calcium carbonate | 10 to 45 parts |
| Borane amine complex | 1 to 10 parts |
| Metal complex activator | 0.0005 to 1.0 |
| | part |
| Aldehyde amine condensation product | 0.5 to 4 parts |

TABLE 1B
List of major (essential) and minor (optional)
components are as follows:

| Major Components | Minor Components |
|---|---|
| Methacrylate monomer | Thermoplastic resin |
| Lewis acid | Fumed silica |
| Inhibitor | Plasticizer |
| Peroxide | Uncoated Calcium carbonate (filler) |
| Polymeric impact modifier | Precipitated Calcium carbonate (filler) |
| Borane amine complex | |
| Metal complex activator | |
| Aldehyde amine | |
| condensation product | |

Suitable alternatives for the major and minor components illustratively include:

Alternative methacrylate monomers may illustratively include: tetrahydrofurfuryl methacrylate, 1-amino-2-hydroxyl propyl methacrylate, 1-amino-3-hydroxy propyl ethacrylate, 1-hydroxyl-2 amino propyl methacrylate, 2-hydroxyl methacrylate, 2-terbutyl amino ethyl methacrylate, butyl methacrylate, C₁-C₁₆ alkyl methacrylates, C₁-C₁₆ epoxy acrylates or methacrylates, cyclohexyl methacrylate, dicyclo pentadienyloxy ethyl methacrylate, diethylene glycol dimethacrylate, dodecyl methacrylate, ethyl hexyl methacrylates, ethyl methacrylate, ethylhexylmethacrylates, ethylmethacrylate, glycidyl methacrylate, glycidyl methacrylate, isobornyl methacrylate, lauryl methacrylate, methylmethacrylate, tetrahydrofurfuryl methacrylate; Di/tri methacrylates include bisphenol-A dimethacrylates, tetrahydrofurane dimethacrylates, hexanediol dimethacrylates, polythylene glycol dimethacrylates, triethylene glycol dimethacrylates, tripropylene glycol dimethacrylates, tetraethylene glycol dimethacrylates, diethylene glycol dimethacrylates, 1,4-butanediol dimethacrylates,1,6-hexanediol dimethacrylates, pentaerythritol tetramethacrylates, trimethylol propane trimethacrylates, trimethylol propane trimethacrylates, di-pentaerythritol monohydroxy pentamethacrylates, pentaerythritol trimethacrylate, ethoxylated bisphenol-A dimethacrylate, ethoxylated trimethylolpropane trimethacrylates, trimethylolpropane propoxylate trimethacrylates, tris(2-hydroxy ethyl)isocyanurate triacrylate, triethyleneglycoldimethacrylate (TEGMA), ethoxylated bisphenol A methacrylate, glycerin dimethacrylate, tri-methylol propane dimethacrylate. Hydroxy methacrylates include 2-hydroxyethyl methacrylate, 2-hydroxypropyl methacrylate, 2-hydroxybutyl methacrylate, 3-hydroxypropyl methacrylate, 2-hydroxypentyl methacrylate, 5-hydroxypentyl methacrylate, 7-hydroxyheptyl methacrylate, 5-hydroxydecyl methacrylate, diethylene glycol monomethacrylate.

Alternative acrylate monomers illustratively include 2-ethylhexyl acrylate, 2-hydroxyl ethylacrylate, 3-hydroxyl propylacrylate, butyl acrylate, C₁-C₁₆ alkylacrylate, C₁-C₁₆ hydroxyl alkylacrylates, C₁-C₁₆ primary amine acrylates, C₁-C₁₆ secondary amine acrylates, cyclohexyl acrylate, ethyl acrylate, ethylacrylate, ethylhexyl acrylates, hexyl acrylate, isobornyl acrylate, lauryl acrylate, methylacrylate, octylacrylate, trimethyolpropane tri acrylate. Hydroxy acrylate monomers include 2-hydroxyethyl acrylate, 2-hydroxypropyl acrylate, 2-hydroxybutyl acrylate, 3-hydroxypropyl acrylate, 4-hydroxybutyl acrylate, 3-hydroxypentyl acrylate, 6-hydroxynonyl acrylate; styrenic monomers such as butylstyrene, chlorostyrene, methyl styrene, n-butyl styrene, styrene, vinyl styrene; other monomers include methoxy polyethylene glycol monomethacrylate, methyl methacrylic acid, N-hydroxymethyl acrylamide, N-hydroxymethyl methacrylamide, butadiene monomers, 2-chloro-1,3-butadiene, 1,3-butadienes, acrylonitrile, fumarate esters, maleate esters, methacrylonitrile, monomethacryloyloxyethyl phthalate, vinyl acetate, vinylidene chloride, N-hydroxymethyl acrylamide, N-hydroxymethyl methacrylamide, acrylamide, methacrylamide, 2-acrylamido-2-methyl propane Sulfonic acid, acrylic acid, methacrylic acid, C₁-C₁₆ acrylosulfonic acids, itaconic acid.

Alternative Lewis acids illustratively include maleic acid, acrylic acid, methacrylic acid, crotonic acid, itaconic acid, benzoic acid, and p-methoxybenzoic acid, formic acid, acetic acid, propionic acid, maleic acid, malic acid, fumaric acid, acrylic acid, pyruvic acid, itaconic acid, nadic acid, benzoic acid, phthalic acids, cinnamic acid, trichloroacetic acid, and saccharin and combinations thereof.

Alternative inhibitors illustratively include: MEHQ, BHT, Phenol, 4-tert butylpyrocatechol, tert-butylhydroquinone, 1,4-benzoquinone, 6-tert-butyl-2,4-xylenol, 2,6-di-tert-butyl-p-cresol, 2,6-di-tert-butylphenol, 1,1-diphenyl-2-picrylhydrazyl, 4-methoxyphenol, phenothiazine, 4-hydroxy-2,2,6,6-tetramethylpiperidin-1-oxyl (4-hydroxy TEMPO).

Alternatives peroxides illustratively include: hydrogen peroxide, benzoyl peroxide, cumene hydroperoxide, tertiary butyl hydroperoxide, methyl ethyl ketone hydroperoxide, and hydroperoxides formed by the oxygenation of various hydrocarbons, such as methylbutene, cetane, and cyclohexene, and various ketones and ethers, t-butyl perbenzoate, diacyl peroxides, ketone hydroperoxides, β-butylperoxybenzoate, methyl ethyl ketone hydroperoxide.

Alternatives to polymeric impact modifier illustratively include: styrene butadiene copolymers; polycarbonates; methyl methacrylate butadiene styrene copolymers (MBS); nitrile rubber; blocked copolymers of styrene butadiene; buna rubbers, acrylonitrile-butadiene-styrene, and combinations thereof; styrene acrylonitrile copolymer (SAN); chlorosulphonated polyethylene; neoprene; a copolymer of ethylene acrylic elastomer, acrylonitrile-styrene-acrylate, poly(methyl methacrylate)-grafted-rubber, and combinations thereof; polybutadiene homopolymer; a copolymer of butadiene and at least one monomer copolymerizable therewith selected from the group consisting of styrene, acrylonitrile and methacrylonitrile, polybutadiene homopolymer and copolymers of butadiene; olefinic urethane reaction products of an isocyanate-functional prepolymer and a hydroxy functional monomer (as mentioned in U.S. Pat. Nos. 4,223,115; 4,452,944; 4,467,071 and 4,769,419); block copolymers and random copolymers including but not limited to polyethylene, polypropylene, styrene-butadiene, polychloroprene, EPDM, chlorinated rubber, butyl rubber, styrene/butadiene/acrylonitrile rubber and chlorosulfonated polyethylene, poly(butadiene-(meth)acrylonitrile or poly(butadiene-(meth)acrylonitrile-styrene, and mixtures thereof; Inclusive as tougheners are the olefinic-terminated polyalkadienes having carboxy ester linking groups and at least one nascent secondary hydroxyl group, such as disclosed in U.S. Pat. No. 5,587,433, A specific example is a 60:40 mixture of glycidyl methacrylate terminated CTBN.

Alternatives to borane amine complex illustratively include: trimethylborane, triethylborane, tri-n-propylborane, triisopropylborane, tri-n-butylborane, triisobutylborane, and tri-sec-butylborane.

Alternatives to metal complex activator illustratively include: copper(II) acetylacetonate, magnesium acetylacetonate, zirconium acetylacetonate, titanium acetylacetonate, cobalt acetylacetonate, copper acetylacetonate and zinc acetylacetonate. A salt or chelate of a transition metal is used, such as cobalt, nickel, manganese; or iron naphthenate, copper octoate, iron hexoate, or iron propionate, copper naphthenate, copper acetoacetate, or copper octoate, organic arsenic, tributyl tin oxide, zinc naphthenate, and copper 8-quinolinate, copper(II) carboxylate salt, copper(II) 2-ethylhexanoate, partial salts of alkali earth metals such as magnesium, calcium, and barium, elements which belong to the copper and zinc families, such transition elements as titanium, vanadium, chromium, manganese, iron, cobalt, nickel, and zirconium.

Alternatives for aldehyde amine condensation product illustratively include: 3,5-diethyl-1,2-dihydro-1-phenyl-2-propylpyridine, tertiary amines, imides, polyamines, cyclicamines, arylamines etc. Suitable tertiary amines may include N,N-dimethyl aniline, N,N-diethyl toluidine, N,N-bis(2-hydroxy ethyl) toluidine and the like. The aldehyde-amine condensation reaction products based on butyraldehyde (3 moles)-aniline (1 mole) and butyraldehyde(3 moles)-butylamine (1 mole) derivatives, where the active ingredient dihydropyridine (DHP) is generated as a result of condensation reaction. The enriched versions of DHP include Reillycat ASY-2, available from Reilly Industries, 3,5-diethyl-1-phenyl-2-propyl-1,2 dihydropyridine (PDHP), and combination of hydrazones dihydropyridines, and combinations of hydroperoxide/sulfonyl chloride/DHP.

Alternatives to thermoplastic resin illustratively include: acrylonitrile butadiene styrene resin, poly methyl methacrylate (PMMA), acrylonitrile styrene acrylate (ASA), polycarbonate resin, poly ethylvinyl alcohols, and combinations thereof.

Alternatives to fumed silica illustratively include: silica, fumed silica (treated or untreated), montmorillonite, clay, bentonite, micronized silica, wood flour, cornstarch, glass fibers, cotton lintners, mica, alumina, silica, perfluoropolymers, polyethylene, and polypropylene powder.

Alternatives to plasticizer illustratively include: DOP, dioctyl phthalate, also known as DEHP, or diethylhexyl phthalate, DINP (diiso nonyl Phthalate), bio-based vegetable base green plasticizers like Finaflex 1200, DPM, DOA, DOP, DEHA, cyclohexane 1,2 dicarboxylate, glycerol triacetate, or combinations thereof.

Alternatives to uncoated calcium carbonate as a filler illustratively include barium sulphate, silica, Kaolin clay, etc.

Alternatives to precipitated calcium carbonate as a filler illustratively include thixocarb 500, Thixocarb 300, coated calcium carbonate, etc.

Not intending to be limited by a particular theory in embodiments of the inventive formulation, monomers may be used to form a polymeric binder via free radical chain growth polymerization. In the inventive formulation Lewis acid is being used to increase the cross-linking density (by H-bonding) of the formulation by copolymerizing with the methacrylate monomer system. Organic peroxides are used in the adhesive formulation to generate free radical species in the formulation, which helps to increase the rate of polymerization. Polymeric impact modifier and Thermoplastic resin are used to increase the impact resistance and toughness of the formulation. Aldehyde amine condensation product is used to accelerate the rate of polymerization along with organic peroxide and metal complex activator. Inhibitor in the present invention may be used to control pot life and which helps to increase the shelf life of the formula.

Embodiments of the inventive adhesive formulation part A may be prepared using the following ingredients as shown in table 2.

TABLE 2
Adhesive Part A Ingredients

| | |
|---|---|
| Methacrylate Monomer | 45 to 65 parts |
| Lewis Acid | 2 to 10 parts |
| Thermoplastic resin | 0.1 to 5 parts |
| Inhibitor | 0.01 to 0.1 parts |
| Initiator | 0.1 to 1 part |
| Thixotropic agent | 0.1 to 2 parts |
| Polymeric Impact modifier | 15 to 35 parts |

Adhesive Part A

For the adhesive Part A, a premix or stock solution of polymeric impact modifier, thermoplastic resin used were prepared in high shear mixers. The amount of each elastomer in each premix solution varies and is dependent on solubility parameters. The breakdown is as follows:

Polymeric impact modifier—30%, methacrylate monomer—70%

Thermoplastic resin—35%, methacrylate monomer 65%

Embodiments of the inventive adhesive formulation part B may be prepared using the following ingredients as shown in table 3.

TABLE 3
Activator Part B Ingredients

| | |
|---|---|
| Plasticizer | 15 to 45 parts |
| Uncoated Calcium carbonate | 10 to 45 parts |
| Precipitated Calcium carbonate | 10 to 45 parts |
| Borane amine complex | 1 to 10 parts |
| Metal complex accelerator | 0.0005 to 1 |
| | part |
| Aldehyde amine condensation product | 0.5 to 4 parts |

The ratio of adhesive portion to activator portion may be anywhere from about 1:1 to 10:1. In commercial and industrial environments, a volume ratio is commonly used for convenience. In a typical aspect of invention, the preferred mixing ratio of adhesive to activator is 10:1 to make it cost effective.

Embodiments of the inventive adhesive formulation have been tested successfully for the pot life and initial development of strength. The resulting formulation is providing a pot life over 3 minutes with more than 100 psi lap shear strength on polypropylene/HDPE substrates in 30 minutes bonding time at room temperature. This strength development may be further accelerated by the application of heat. In another aspect of invention, heat acceleration studies were carried out using a hot air oven at 50° C. and 70° C. temperatures. The retention time of the bonded substrates in the oven was varied from 10 to 15 minutes for 500° C. as well as 700° C. for heat curing. Substrates were bonded at room temperature and clamped with binder clips to obtain a uniform pressure on the bonded area and subjected to respective temperature for 10 and 15 minutes respectively. After 10 and 15 minutes of accelerated curing samples were taken out from hot air oven and cool down to room temperature for 10 minutes. After 10 minutes of cooling down the lap shear strength measurements was immediately determined using the ASTM D1002 test method.

The results are summarized in table 4.

TABLE 4
Pot life, development of strength (LSS in psi) profiles of
room temperature and heated (62° C./5 days) exposed samples.

| | Pot-Life | Development of Strength (LSS in psi) | | | | |
|---|---|---|---|---|---|---|
| Description | (min. sec) | 30 min | 45 min | 60 min | 2 hrs | 24 hrs |
| Room | 3.15 | 108 | 220 | 555 | 805 | 993 |
| Temperature | | | | | | |
| Sample | | (CF) | (CF) | (CF) | (CF) | (SF) |
| 62° C./5 days | 3.50 | 133 | 227 | 684 | 760 | 1001 |
| Exposed sample | | (CF) | (CF) | (CF) | (CF) | (SF) |

The adhesive system showed more than 100 psi lap shear strength in 30 mins. This ability to generate faster strength within 30 mins and over the broad time intervals like 45 mins, 60 min, 2 hrs. and 24 hrs. is an advantage of the inventive compositions over the prior art. The data demonstrate the excellent shelf-stability of the adhesive systems of the invention, with no depletion in properties even after 5-7 days storage at the elevated temperature.

The present invention is further described with respect to the following non-limiting examples. These examples are intended to illustrate specific formulations according to the present invention and should not be construed as a limitation as to the scope of the present invention.

### Example 1. Compounding Of Two-Part Inventive Formulation

A process is provided for producing an adhesive formulation produced by free radical polymerization to bond to a low surface energy substrate.

An adhesive Part A may be produced as a premix or stock solution of polymeric impact modifier, thermoplastic resin used were prepared in high shear mixers. The amount of each elastomer in each premix solution varies and is dependent on solubility parameters. The breakdown is as follows:

Polymeric impact modifier—30%, methacrylate monomer—70%

Thermoplastic resin—35%, methacrylate monomer—65%

The premix preparation process may begin by adding the methacrylate monomer to the mixer. This may be followed by adding in a very slow manner the elastomer under moderate mixing to avoid formation of lumps. After the elastomer is completely added to the monomer in a cleaned kettle, the kettle is closed to avoid monomer loss. In a separate kettle thermoplastics resin is mixed with methacrylate monomer and stirred well using a mechanical mixer at 100-200 rpm speed at 60-70° C. temperature until a homogeneous premix material without any lump formation is obtained. The speed of agitation may be adjusted higher with built in viscosity, and the mixing may continue until the elastomer is fully dissolved. Once dissolved, the premix solution is cooled to room temperature before being packaged into appropriate plastic containers. All other ingredients may be combined by direct addition and mixed with a high shear mixer until a homogenous paste is obtained. Each blended mass is rapidly cooled to room temperature to control monomer loss.

Activator Part B may be produced by mixing together ester plasticizer, reducing agent, and metal complex activator in the double planetary mixer. The mixture is stirred well, and a mixture of calcium carbonate is added in with continuous stirring to get a homogeneous mass. The batch is cooled, and borane amine complex is added. The batch may be degassed and packaged into an appropriate plastic container.

The ratio of adhesive portion to activator portion may be anywhere from about 1:1 to 10:1. In commercial and industrial environments, a volume ratio is commonly used for convenience. In a typical aspect of invention, the preferred mixing ratio of adhesive to activator is 10:1 to make it cost effective. It is noted that the prepared activator formulation has been used along with the adhesive part formulation in 10:1 adhesive:activator volume ratio.

### Example 2. Heat Cured Lap Shear Strength Testing

Table 5 summarizes heat curing lap shear strength values at 50 and 70° C. (10 minute and 15 minute dwell time intervals) temperatures using a Universal Testing Machine (UTM) according to the ASTM D1002 standard procedure. Furthermore, it is important to mention that in all the measurements, cohesive failure (CF) mode was observed for the bonded substrates and after 24 hrs. of curing observed substrate failure (SF) mode.

TABLE 5
Accelerated heat curing lap shear strength in psi

| | | | | |
|---|---|---|---|---|
| Heat temperature curing | 50° C. | 50° C. | 70° C. | 70° C. |
| Heat curing time | 10 min | 15 min | 10 min | 15 min |
| Cooling at room | 10 min | 10 min | 10 min | 10 min |
| temperature | | | | |
| Lap shear strength | 138 (CF) | 631(CF) | 752 (CF) | 910 (Not |
| in psi | | | | broken |
| | | | | substrate |
| | | | | elongated) |

### Example 3. Lap Shear Strength in Psi on Glass Fiber Filled Polypropylene Substrate with Different Environmental Test Conditions. RH is Relative Humidity and SF is Substrate Failure

The inventive formulation is further tested on the glass filled polypropylene substrates and the test data is summarized in Table 6. The debonded adhesive joints were visually inspected to determine the failure mode. It is important to note that, in each case substrate failure is observed indicating much higher bond strength under different environmental conditions.

TABLE 6
Lap shear strength in psi on glass fiber filled polypropylene
substrate with different environmental test conditions.
RH is relative humidity and SF is substrate failure

| Test Description | Test Condition | LSS in psi |
|---|---|---|
| Standard Overlap | 23° C. & 50% RH for 7 days | 1036 (SF) |
| Shear Test | | |
| Heat Aging Test | 120° C. for 24 hours | 687 (SF) |
| Heat Aging Test | 90° C. for 21 days | 779 (SF) |
| Humidity & Heat Aging | 70° C. & 94-100% RH for 21 days | 784 (SF) |
| Resistance to | 10 cycles as per PV 1200 | 1003 (SF) |
| environmental cycle test | | |

The bond thickness of 0.2 mm was maintained for all above tests. Resistance to environmental cycle test is carried out as per the guidelines of PV 1200 standard. For environmental cyclic test, bonded samples were kept 23° C. and 50% RH for 7 days and then started the test as per PV 1200 cycle guideline. RT and RH to 80° C. and 80% RH, 60 minutes→80° C. and 80% RH, 240 minutes→80° C. and 80% RH to (−40) ° C., 120 minutes→(−40) ° C., 240 minutes→(−40) ° C. to 80° C. and 80% RH, 120 minutes. A loop of these conditions was conducted for 10 cycles.

### Example 4. Testing of Lap Shear Strength on Different Substrates

The formulation in the present invention was successful in bonding on various substrates illustratively including HDPE, LDPE, Nylon, Polypropylene, ABS, KTL, PVC, GBMS, G60, polyacetals, glass filled polypropylene, etc. Average lap shear strength in psi tested after 24 hours curing at room temperature along with failure mode is tabulated in below in table 7.

TABLE 7
Lap shear strength in psi on various substrates.

| | Lap Shear Strength | | | |
|---|---|---|---|---|
| | (psi) | | Average | Failure |
| Substrate | Sample 1 | Sample 2 | LSS (psi) | mode |
| e-coated | 1972 | 1865 | 1918 | Cohesive |
| KTL | | | | |
| Aluminum | 1928 | 1813 | 1870 | Cohesive |
| GBMS | 1853 | 1724 | 1788 | Cohesive |
| CFRP | 1781 | 1508 | 1644 | Cohesive |
| FRP | 1535 | 1393 | 1464 | Cohesive |
| G60 | 1519 | 1486 | 1502 | Cohesive |
| KTL | 1140 | 1123 | 1132 | Cohesive |
| HDPE | 1089 | 1009 | 1049 | Cohesive |
| PVC | 1050 | 956 | 1003 | Substrate |
| PMMA | 925 | 915 | 920 | Substrate |
| Nylon | 867 | 900 | 883 | Cohesive |
| Filled PP | 797 | 723 | 760 | Substrate |
| ABS | 764 | 726 | 745 | Substrate |
| Chromate | 745 | 731 | 738 | Chromate layer |
| | | | | peeled out. |

### Example 5. Pot Life Determination Using Overlap Shear Strength

Adhesive system of the present invention is tested for pot life determination study by evaluating ultimate lap shear strength after bonding specimens at different time intervals such as 30, 45, 60 seconds up to 3 minutes. Data for pot life determination is summarized in table 8, and indicates that the bond formed by the inventive composition displays remarkable adhesive strength even up to 3 minutes of bonding, considering the application on bigger assemblies.

TABLE 8
Pot life determination using overlap shear strength

| Time | 30 sec | 60 sec | 90 sec | 120 sec | 150 sec | 180 sec |
|---|---|---|---|---|---|---|
| LSS in psi | 913 (SF) | 899 (SF) | 942 (SF) | 860 (CF) | 899(SF) | 841 (SF) |

### Example 6. Comparative Example Between the Inventive Formulation and U.S. Pat. No. 9,382,452

As previously described embodiments of the inventive formulation include a metal accelerator that has markedly increased the activity of adhesive bonding, while reducing agents initiate the polymerization process in the presence of an initiator. In the newly disclosed inventive formulation, a reducing agent based on aldehyde-amine condensate reaction products is used in combination with an initiator (by keeping separated from each other in either Component A or Component B). Furthermore, thermoplastic resin has enhanced toughness of the material in synergy with polymeric impact modifier in present inventive formula. It is noted that the adhesive formulation disclosed in U.S. Pat. No. 9,382,452 is devoid of these ingredients and resulted in a slower developing lap shear strength as compared to embodiments of the inventive formulation described herein. For example, the 452′ formulation obtains an overlap shear strength of 50-60 psi on polypropylene substrates within 30 minutes of bonding. Whereas, the present invention is able to achieve more than 100 psi of strength polypropylene substrates within 30 minutes of bonding. Table 9 provides a comparative summary between the 452′ formulation and the newly disclosed formulation.

TABLE 9
Comparison of Pot-life and development of shear strength
between 452′ formulation and the inventive formulation

| | Pot-Life | Development of strength (LSS in psi) | | | | |
|---|---|---|---|---|---|---|
| Description | (min. sec) | 30 min | 45 min | 60 min | 2 hrs | 24 hrs |
| Prior art | >3.00 | 50.0 | NA | 253 | 332 | 754 |
| adhesive | | | | | | |
| (U.S. Pat. No. | | | | | | |
| 9,382,452) | | | | | | |
| Current | 3.15 | 108 (CF) | 220 | 555 | 805 | 993 |
| inventive | | | (CF) | (CF) | (CF) | (SF) |
| formula | | | | | | |

### Example 7. Comparative Data of the Invented Composition Over Similar Prior Art Products Known in the Market

Typical strength rate build up mentioned in the Technical data sheet (February 2016, Page 5 of 9) of 3M Scotch-Weld® Structural plastic adhesive DP 8005 Off White on HDPE substrate is 80 psi in 2 hours whereas in current invention 80 psi is achieved within 30 minutes on HDPE substrate.
Time to handling strength mentioned in the Technical data sheet (February 2016, Page 2 of 9) of 3M Scotch-Weld® Structural plastic adhesive DP 8005 Off White is 2-3 hrs; minimum of 50 psi shear at 73° F./23° C.) which can be achieved in current invention in less than 30 minutes at 73° F./23° C.

Patents and references cited in the application are indicative of the skill in the art. Each of these patents and references is hereby incorporated by reference to the same extent as if each reference was individually incorporated by reference.

1. A two part adhesive formulation comprising:
an adhesive part comprising:
free-radical curable monomers, each of said free-radical curable monomers containing at least one acrylate moiety or at least one methacrylate moiety;
a Lewis acid;
a thermoplastic resin; and
a polymeric impact modifier;
an activator part present in a 1:1 weight ratio of said adhesive part: said activator part, said activator part comprising:
an activator of borane-amine complex of at least one of trimethylborane, triethylborane, tri-n-propylborane, triisopropylborane, tri-n-butylborane, triisobutylborane, and tri-sec-butylborane, or a combination thereof;
a metal accelerator; and
a grafted elastomer with a thermoplastic additive.

2. The formulation of claim 1 wherein said free-radical curable monomer amount constitutes the majority by weight of the total formulation.

3. The formulation of claim 1 wherein said polymeric impact modifier is methyl methacrylate butadiene styrene copolymer, a block copolymer of styrene-butadiene, acrylonitrile-butadiene-styrene, or a combination thereof.

4. The formulation of claim 1 wherein said Lewis acid is a carboxylic acid.

5. The formulation of claim 1 further comprising at least one of said free-radical curable monomers, or said Lewis acid, said dimethylacrylate monomer or said trimethylacrylate monomer is present in said activator part.

6. The formulation of claim 1 further comprising a stabilizer in at least one of said adhesive part or said activator part.

7. The formulation of claim 1 further comprising a filler in at least one of said adhesive part or said activator part.

8. The formulation of claim 7 wherein said filler is carbonate particulate.

9. The formulation of claim 1 wherein said free-radical curable monomers further comprise dimethylacrylate monomer, trimethylacrylate monomer, or a combination thereof is present in said activator part.

10. The formulation of claim 1 further comprising at least one of an antioxidant, polymerization inhibitor, dye, thixotrope, glass microspheres, or a combination thereof in at least one of said adhesive part or said activator part.

11. The formulation of claim 1 further comprising halogenated tallow alkyl amines in at least one of said adhesive part or said activator part.

12. A two part adhesive formulation comprising:
an adhesive part comprising:
one or more free-radical curable monomers, each of said one or more free-radical curable monomers containing at least one acrylate moiety or at least one methacrylate moiety;
a Lewis acid;
a thermoplastic resin; and
a polymeric impact modifier;
a polyfunctional monomer of dimethylacrylate monomer, trimethylacrylate monomer, or a combination thereof; and
an activator part present in a 10:1 weight ratio of said adhesive part: said activator part, said activator part comprising:
a borane-amine complex of at least one of trimethylborane, triethylborane, tri-n-propylborane, triisopropylborane, tri-n-butylborane, triisobutylborane, and tri-sec-butylborane, or a combination thereof.

13. The formulation of claim 12 further comprising a grafted elastomer present in at least one of said adhesive part or said activator part.

14. A process of applying an adhesive to a substrate comprising:
mixing together said adhesive part and said activator part of claim 1 to form a mixture wherein each of said adhesive part and said activator part has storage stability at 50° C. for 30 days such that viscosity at 30 days is within 40% of an initial viscosity of said adhesive part or said activator part;
applying said mixture to said substrate; and
allowing said mixture to cure to achieve an initial strength of at least 345 kiloPascals (kPa) within 30 minutes for the 1:1 weight ratio and 40 minutes for the 10:1 weight ratio.

15. The process of claim 14 wherein the 1:1 weight ratio and the 10:1 weight ratio are each within ±10% of 1:1 or 10:1.

16. The process of claim 14 wherein the substrate is a low-energy substrate and said mixture cures thereon to form an exposed coating.

17. The process of claim 14 further comprising contacting a second substrate with said mixture during cure to create a bond between the substrate and the second substrate.

18. The process of claim 17 further comprising fixturing the substrate and the second substrate in a joint position and in simultaneous contact with said mixture for a period of time between 2 and 120 minutes during the free-radical cure and then releasing the substrate and the second substrate from the fixture.

19. The process of claim 14 wherein the substrate is one of a polyolefin, acrylonitrile-butadiene-styrene, polycarbonate, polybutylene terephthalate, e-coated steel, grit blasted mild steel, or glass.
